(19) United States
(12) Patent Application Publication
(10) Pub. No.: US 2025/0329120 A1
(43) Pub. Date: Oct. 23, 2025

(54) DEVICES AND METHOD FOR DETECTING BLOOD

(71) Applicant: Track N Trail, LLC, Huntsville, AL (US)

(72) Inventor: Mark David Hose, Huntsville, AL (US)

(73) Assignee: Track N Trail, LLC, Huntsville, AL (US)

(21) Appl. No.: 19/054,904

(22) Filed: Feb. 16, 2025

Related U.S. Application Data
(63) Continuation-in-part of application No. 18/144,804, filed on May 8, 2023.
(60) Provisional application No. 63/339,266, filed on May 6, 2022.

(51) Int. Cl. G06T 19/00; A01M 31/00; G01C 21/20; G06T 7/70; G06T 19/20; G06V 20/20; G06V 20/50

(52) U.S. Cl. CPC G06T 19/006; A01M 31/002; G01C 21/20; G06T 7/70; G06T 19/20; G06V 20/20; G06V 20/50; G06T 2219/2012

(57) ABSTRACT

A device of the present disclosure has a camera and a display. Further, the device has a processor that determines the presence of blood based on images captured by the camera and generates images on the display indicative of the blood determined.

### CROSS REFERENCE TO RELATED APPLICATION

The present application claims priority to U.S. patent application Ser. No. 18/144,804 entitled Systems and Methods for Detecting Blood and filed on May 8, 2023, which claims priority to U.S. Provisional patent application Ser. No. 63/339,266 entitled “Apparatus for Detecting Blood” and filed on May 6, 2022, both of which are incorporated herein by reference in their entirety.

### BACKGROUND

Hunters spend considerable time recovering game animals that have been shot. When game animals run away their blood trails can become increasingly faint to non-existent. Blood trailing is particularly difficult for hunters with color deficiencies (colorblindness). Many color deficient hunters have difficulty seeing the red blood. These hunters must depend on other features when trailing blood such as the glistening of wet blood droplets (which appear as droplets of water). Blood trailing can occur at any time of day or night. During daytime, recovery of the blood trail is observed in the presence of natural sunlight. During nighttime, recovery of the blood trail requires illumination from an artificial light source (e.g., flashlight or lantern). Hunters know that the blood trail can come down to a single drop of blood; which can mean the difference in a lost animal or a found trophy. Additionally, crime-scene investigators use luminol in conjunction with special lighting to detect trace amounts of blood at crime-scenes. While luminol helps expose the blood, it contaminates the blood.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views. The present disclosure contains at least one drawing executed in color. Copies of this patent or patent application publication with color drawing(s) will be provided by the United States Patent and Trademark Office (USPTO) upon request and payment of the necessary fee.

FIG. 1 is a diagram of an exemplary blood detection and alerting device in use in accordance with an embodiment of the present disclosure.

FIG. 2 is a block diagram of the exemplary device shown in FIG. 1.

FIG. 3A is the detection and alerting device of FIG. 1, displaying an image identifying blood with modified display colors.

FIG. 3B is the detection and alerting device of FIG. 1, displaying the image identifying blood with modified display colors (blue scale with the detected blood shown in yellow).

FIG. 4 is the detection and alerting device of FIG. 1, displaying the image identifying blood with modified display colors (grayscale with the detected blood shown in red) and exemplary touchscreen controls.

FIG. 5 is a detection and alerting device of FIG. 1, displaying the image identifying blood with modified display colors (grayscale with the detected blood shown in red) and exemplary touchscreen controls that include a pop-up menu used to select a display color for the pixels detected to be blood, and to select the presentation style for the pixels that are detected not to be blood.

FIG. 6A is an isometric view of the detection and alerting device of FIG. 4.

FIG. 6B is an isometric view for a detection and alerting device of FIG. 4, where the device is looking back at virtual waypoint markers that are displayed in a three-dimensional augmented reality fashion.

FIG. 7 is the detection and alerting device of FIG. 1, displaying waypoint markers in a two-dimensional fashion.

FIG. 8A is the detection and alerting device of FIG. 1, displaying an exemplary dashboard that includes current and predicted weather data.

FIG. 8B is the detection and alerting device of FIG. 1, displaying an exemplary training module.

FIG. 9 is a graph of the spectral transmittance of blood and representative camera response curves from Bayer pattern R, G, B filters, related to the image processing of a detection and alerting device of FIG. 1.

FIG. 10A is a three-dimensional RGB (red, green, blue) color-space, used for exemplary processing, for a detection and alerting device of FIG. 1.

FIG. 10B shows colored pixels from the camera images mapped into a three-dimensional RGB (red, green, blue) color-space, for a detection and alerting device of FIG. 1.

FIG. 11A is a three-dimensional RGB (red, green, blue) color-space, with a pyramid region that encapsulates the colors that represent blood detected, for a detection and alerting device of FIG. 1.

FIG. 11B is a three-dimensional RGB (red, green, blue) color-space, with a larger pyramid region that encapsulates the colors that represent blood detected, for a detection and alerting device of FIG. 1.

FIG. 12A is a three-dimensional representation of an elliptical paraboloid, with dimension r, g, and b; and an offset value defined as “Rmin”, used for the processing of a detection and alerting device of FIG. 1.

FIG. 12B is a portion of a three-dimensional representation of an elliptical paraboloid, with dimension r, g, and b; and an offset value defined as “Rmin”, used for a detection and alerting device of FIG. 1.

FIG. 13A is a three-dimensional RGB (red, green, blue) color-space, with an elliptical paraboloid shaped volume that encapsulates the colors that represent blood detected, for a detection and alerting device of FIG. 1.

FIG. 13B is a three-dimensional RGB (red, green, blue) color-space, with a larger elliptical paraboloid shaped volume that encapsulates the colors that represent blood detected, for a detection and alerting device of FIG. 1.

FIG. 14A is a rear view of a cradle device used in conjunction with a detection and alerting device of FIG. 1, to provide additional lighting.

FIG. 14B is a front view of a cradle device used in conjunction with the detection and alerting device of FIG. 1, to provide additional lighting.

FIG. 15A is a rear view of a larger cradle device used in conjunction with a detection and alerting device of FIG. 1, to provide additional lighting.

FIG. 15B is a front view of a larger cradle device used in conjunction with a detection and alerting device of FIG. 1, to provide additional lighting.

FIG. 16 is an operator using the detection and alerting device of FIG. 1, in a “hand-held” configuration to track blood.

FIG. 17 is an operator using the detection and alerting device of FIG. 1, in a “metal detector” configuration to track blood.

FIG. 18 is an operator using the detection and alerting device of FIG. 1, in an augmented or “extended reality headset” (XR headset) configuration to track blood.

FIG. 19 is an exemplary display content when the detection and alerting device of FIG. 1, is being used in a “headset” configuration.

FIG. 20 is a front view of a cradle device used in conjunction with the detection and alerting device of FIG. 1, to provide additional lighting, optical filtration, and optical magnification.

FIG. 21 is a flowchart of exemplary architecture and functionality of the detection and alerting device of FIG. 1.

### DETAILED DESCRIPTION

The present disclosure is devices and methods for detecting blood and generating alerts. A device in accordance with an embodiment of the present disclosure assists hunters or crime-scene investigators in the detection of blood. The device alerts the operator when it detects the presence of blood. In one embodiment, the device includes a camera, camera processing, and a display, which represent the basic components for obtaining real-world imagery, processing the imagery, and displaying the resultant imagery. The device further comprises control settings, alerts, and lighting controls, which optimize the operation of the device. The device further provides mapping functions, training functions, and an environmental conditions dashboard, to expand the utility of the device.

The device captures imagery from the camera, processes that imagery, and renders the corresponding resultant imagery to a display. The device processes images and determines which pixels are detected as blood, and which pixels are not. The device performs color conversions that apply to both the blood detected pixels and to the other non-blood detected pixels. Exemplary conversions for the blood detected pixels include: a null conversion where the pixels are presented in their original color, conversion to bright red, conversion to bright green, and conversion to bright yellow. The conversions of the blood detected pixels to bright green and bright yellow provide additional contrast and visibility for color-deficient operators. The conversions for non-blood detected pixels include conversion to shades of gray, conversion to shades of green, conversion to shades of blue, and conversion to a fixed color. Additional conversions for non-blood detected pixels include pseudo color and inverted (negative).

In one embodiment, the device is used in a hand-held capacity with the described methods carried out via an App (software application) executing on a camera-enabled mobile device, e.g., smart phone like an iPhone.

In one embodiment, the device is a camera-enabled mobile device hosted within a cradle device that provides additive and subtractive lighting functions. Additive lighting is effectuated via the inclusion of a flashlight function (e.g., LED lights). Subtractive lighting is effectuated via optical filters (e.g., neutral density filters) located directly in the field of view of the camera.

In one embodiment, the device is a camera-enabled mobile device that may be hosted in a head-worn capacity or perhaps hosted using a hand-held extension pole device (e.g., like a metal detector).

In one embodiment, the device is a camera-enabled mobile device like commercial mixed reality headsets like the Apple Vision Pro and Meta Quest devices, as these devices contain the requisite processor, display, and various components capable of providing alerts (audible, visual).

In one embodiment, the device may be implemented in a custom (without a camera-enabled mobile device) solution capable of implementing some of the methods described herein above. Additional methods may be used by other devices or systems in accordance with an embodiment of the present disclosure. The camera can even be physically separated with the imagery passed into a separate processing unit (e.g., remote wireless camera module sending imagery to a mobile device via Wi-Fi connection).

The device for detecting the presence of blood combines both theoretical data (models, assumptions, logic) and empirical data (observations, experiments, measurements). The theorical data includes considerations related to the optical properties of blood (e.g., transmittance and absorption spectrums of blood), while the empirical data includes RGB values observed from actual blood trails (e.g., daytime, nighttime, fresh, dry, arterial, veinous). Both types of data are essential-theoretical data helps in developing ideas and expectations, while empirical data ensures accuracy and real-world applicability. Blood is detected to be present when the processor computations indicate in the affirmative.

The blood of big game animals like whitetail deer and elk shares key similarities with human blood, as both contain red and white blood cells, platelets, and plasma, facilitating oxygen transport, clotting, and immune defense. Oxygenated blood is bright red, while deoxygenated blood is darker, and clotting mechanisms function similarly. Both species have a four-chambered heart and a circulatory system that pumps blood through arteries and veins. Differences exist in red blood cell (RBC) shape and hemoglobin concentration, but overall, the similarities aid in understanding blood trails for ethical game recovery, as variations in blood color and consistency can indicate shot placement and wound severity. The device can examine the blood detected and further classify likely origins of the blood such as veinous or arterial, and lung, heart, or liver.

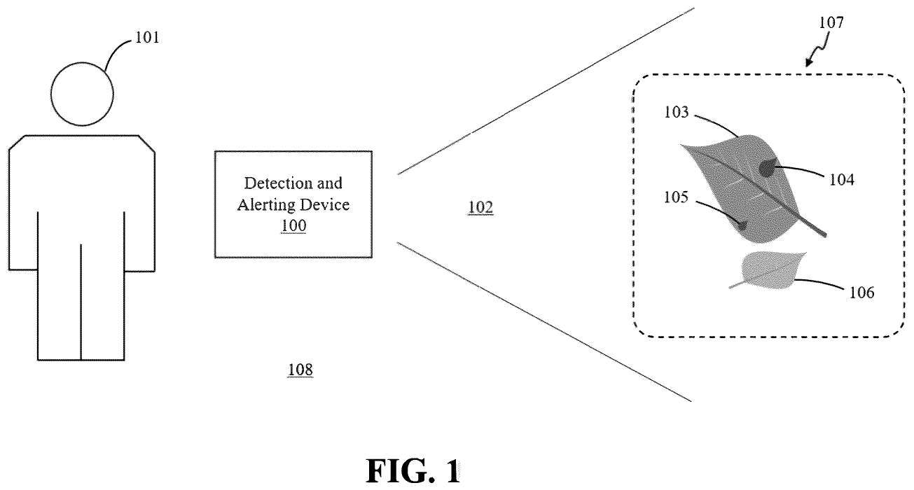

FIG. 1 is an operator 101 using an exemplary detection and alerting device 100 in accordance with an embodiment of the present disclosure. As will be described further herein, the device 100 may be held by the operator 101 or may be worn on the operator's person, e.g., via augmented reality headset.

The detection and alerting device 100 comprises a camera (not shown) that has a field of view (FOV) 102. The detection and alerting device 100 captures an image 107 in its FOV 102. In the embodiment shown, the image 107 comprises a green leaf 103, a large blood drop 104, a small blood drop 105, and an orange leaf 106. The detection and alerting device 100 detects if blood is present in the image 107 and if the detection and alerting device 100 determines that blood is present, the detection and alerting device 100 alerts the operator 101 via an audible, visual, or vibratory alert, each of which is described further herein.

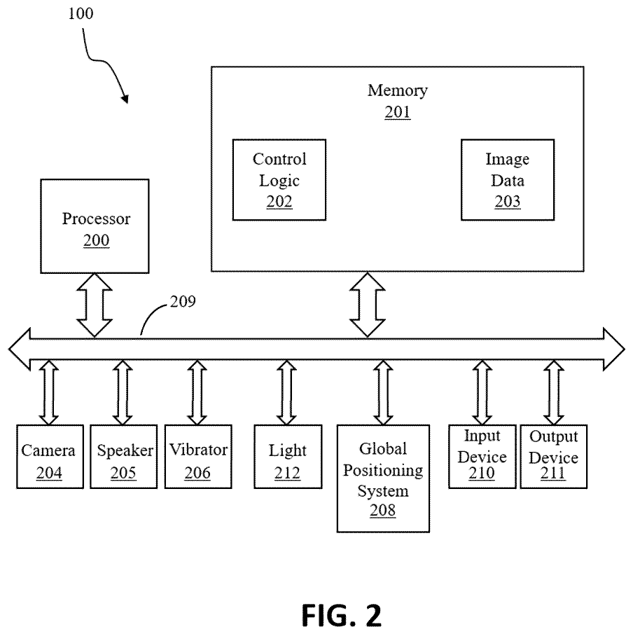

FIG. 2 is a block diagram of an exemplary detection and alerting device 100 as shown in FIG. 1 in accordance with an embodiment of the present disclosure.

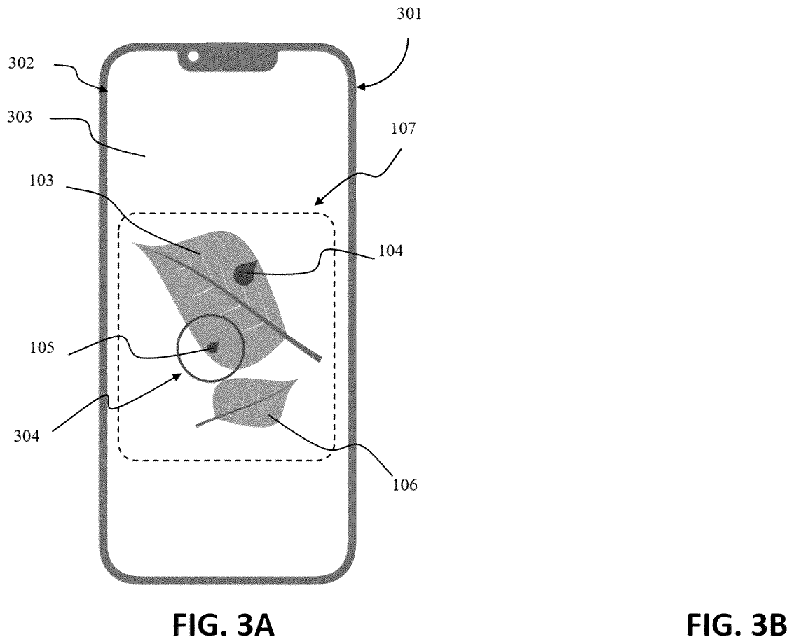

The detection and alerting device 100 comprises control logic 202 and data 203 stored in memory 201. The control logic 202 controls the functionality of the detection and alerting device 100. The control logic 202 can be implemented in software, hardware, firmware, or any combination thereof. In an exemplary embodiment illustrated in FIGS. 3A and 3B, the control logic 202 is implemented in software and stored in memory 201.

Note that the control logic 202, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of detection and alerting device 100 depicted by FIG. 2 comprises at least one conventional processor 200, such as a digital signal processor (DSP) or a central processing unit (CPU), that communicates with and drives the other elements within the detection and alerting device 100 via a local interface 209, which can include at least one bus. Further, the processor 200 is configured to execute instructions of software, such as the control logic 202.

An input device 210, for example, a touchscreen, can be used to input data from the operator 101 (FIG. 1) of the detection and alerting device 100, and an output device 211, for example, a display screen (e.g., a liquid crystal display (LCD)), can be used to output data to the operator 101. The output device 211 is any type of device configured to provide a visual alert to the operator 101.

In one embodiment, the detection and alerting device 100 further comprises a camera 204. The camera 204 may be any type of camera that exhibits a FOV 102 and captures images 107 (FIG. 1). As examples, the camera 204 may be a standard camera, an ultra-wide camera, a telephoto or periscope zoom camera, a macro camera, a monochrome camera, or a depth sensor or three-dimensional sensor. Other types of cameras may be used in other embodiments.

Further, the detection and alerting device 100 comprises a speaker 205. The speaker 205 is any type of device capable of emitting an audible alert to the operator 101. The detection and alerting device 100 also comprises a vibrator 206. The vibrator 206 is any type of device capable of providing a sensory vibrational alert to the operator 101.

In operation, the operator 101 carries or wears the detection and alerting device 100. The operator 101 activates the camera 204 and positions the camera 204 so that the FOV 102 captures images in the environment 108 (FIG. 1), and the processor 200 stores data indicative of the captured images as data 203. Further, the processor 200 analyzes the data 203 to detect if there is blood 104 and 105 (FIG. 1) present in the environment 108 based upon the image data 203.

If the processor 200 detects that blood is present, the processor 200 transmits a signal to the speaker 205, which emits an audible sound. In addition, the processor 200 may transmit a signal to the vibrator 206 which provides a sensory vibrational alert, or displays image data 203 or other text or symbology to the output device 211 visually alerting the operator 101 to the presence of blood. Note that the way the operator 101 is alerted regarding the presence of blood may be selected and manipulated by the operator 101 via the input device 210. In one embodiment, an LED light 212 may be used to increase ambient lighting in low light environments.

FIG. 3A is a detection and alerting device 100 of FIG. 1, implemented using a smart phone device 301, comprising a touchscreen display 302 displaying a graphical user interface (GUI) 303. In the embodiment shown, the processor 200 (FIG. 2) detects blood in the image 107 and renders to the touchscreen display 302 said blood detected in the environment 108 (FIG. 1), which will be described further herein. In this regard, the processor 200 converts colors detected and renders a green leaf 103 and an orange leaf 106 in gray scale.

Note that in the embodiment shown, pixels of blood 104 and 105 detected are presented in a different color than grayscale. In this regard, the blood 104 and 105 are rendered red in color to indicate the presence of blood.

FIG. 3B is the detection and alerting device 100 of FIG. 1, implemented using the smart phone device 301, displaying the graphical user interface 303 unlike as it is displayed in FIG. 3A. In this regard, the processor 200 converts the detected blood and renders pixels of the blood 104 and 105 in a user specified “blood presentation color” which is bright yellow (RGB: 255, 255, 0) and converts image data to and renders the leaf 103 and the leaf 106 in shades of blue.

In the embodiment shown, the processor 200 converts the image data through blue-scale conversion by zeroing the red and green components of the RGB (red, green blue) pixel, or sometimes copying the green component of the RGB pixel into the blue component before zeroing the red and green components. The conversion provides improved contrast where the detected blood drops 104 and 105 stand out against the blue-scale imagery. The processor 200 can also evaluate the size of the blood drops detected and draw circles 304 and 305 (or other shapes) around specks of blood making them more apparent. Seeing the small specks of blood on the display in bright daylight can be difficult; and the superposition of circles around the specks help draw attention to the area(s) on the display where blood has been detected. The processor 200 can also be applied color conversion to those pixels detected as non-blood; and the processor 200 may perform the conversion by copying the green pixel component for the non-blood pixels into the red and blue components of the pixel. For example, a color like RGB (12, 100, 128) that has been detected not to be blood, is converted to a grayscale value of RGB (100, 100, 100). The processor 200 may also average the R, G, and B intensities for each pixel, and replace the R, G, B intensities with the average value to apply gray scale. The shades of gray can also be calculated as 0.299×R+0.587×G+0.114×B, where this calculated value is copied into all three RGB components of the pixel.

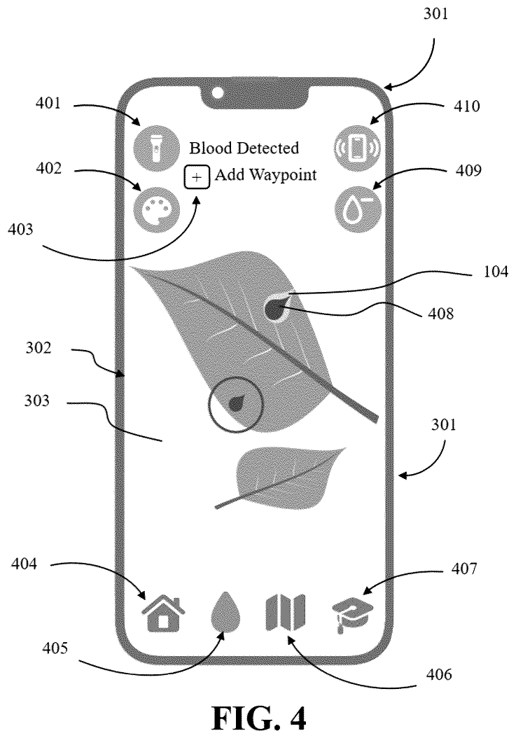

FIG. 4 is the smart phone device 301 displaying a graphical user interface (GUI) 303 on the touchscreen display 302, and the GUI 303 further comprises controls 401, 402, 409, and 410 an operator 101 may select to manipulate characteristics of the image the processor 200 displays. The controls 401, 402, 409, and 410 can be toggled or the processor 200 may display a menu (not shown) for color selection. When a light enable control 401 is selected, the processor 200 toggles an LED light 212 (FIG. 2) on and off. When a color selection control 402 is selected, the processor 200 pulls up a menu (not shown) to allow selection of the blood-presentation color (that is the color that the blood is to be presented) and selection of the background color conversion method (e.g., blue-scale) the processor 200 applies to all pixels that are not detected as blood. When an alert control 410 is selected, the processor 200 enables and disables alerts that may include audible alerts (heard via integral speaker 205), vibrational alerts (felt via integral haptic vibration motor 206), and visual alerts (seen on the touchscreen display 302, e.g., “Blood Detected” message presented with a dynamic waypoint recording control 403).

When the processor 200 detects that blood is present in the image, and the processor 200 may add a waypoint marker (not shown) when the operator 101 touches a dynamic waypoint recording control icon 403 (plus sign). When the operator 101 touches the icon 403, the processor 200 records the immediate geographical position of the operator 101 and device 100, and the orientation of the device 100, and stores it for subsequent display onto two-dimensional (2D) maps or onto the touchscreen display 302 in a three-dimensional (3D) augmented reality capacity.

When sensitivity control 409 is selected, the processor 200 detects how much variation will result in the processing of blood detected. In one embodiment, the sensitivity control 409 can be a slider style control with a range of continuous settings, or in another embodiment, the control may be a toggle between high and low settings. When the operator 101 sets sensitivity to a low setting (e.g., the sensitivity icon 409 shown as a blood drop with a minus sign) the processor 200 may display only an image indicating blood detected for bright red blood (e.g., oxygenated arterial blood). When the operator 101 sets sensitivity to a high setting (e.g., the sensitivity icon 409 would be shown as a blood drop with a plus sign) the processor 200 may display blood detected on both bright red blood (e.g., oxygenated arterial blood), and further include other variations of blood such as darker blood (e.g., veinous blood or drying blood). It should be noted that when a blood drop is observed by a camera, the blood drop typically subtends (covers) multiple image pixels, and these pixels may show up with many disparate shades of red (center versus edges of the blood drop). When sensitivity is set high, all pixels of the blooddrop 104 may be completely detected as blood and displayed in its entirety in the specified blood-presentation color. However, if the sensitivity is set low, the same pixels of the blood drop 104 may have only portions detected as blood, and pixels of the smaller resultant blood drop 408 would be displayed in the specified blood-presentation color. The GUI 303 also has touchscreen icons that support four interrelated software modules: blood-tracking 404, dashboard 405, maps 406, and training 407.

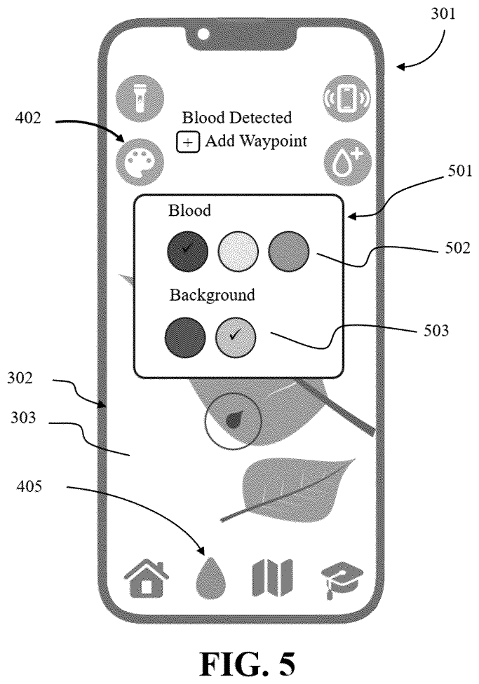

FIG. 5 is the smart phone device 301, displaying the graphical user interface 303 on the touchscreen display 302, and the GUI 303 further comprises controls for a menu 501 that the processor 200 displays when the color selection control 402 is selected. The menu 501 comprises a palette 502 the operator 101 selects to control the blood-presentation color (e.g., converted bright red, converted bright green, converted bright yellow); and a color conversion method palette 503 (e.g., blue-scale, gray-scale) the operator 101 selects to control pixels that are not detected as blood. Once the palette selections 502 and 503 have been made, the color selection control 402 can be touched to remove the menu 501. In one embodiment, the color selection control 402 is available when exercising the blood-trailing module 405 of the software (App).

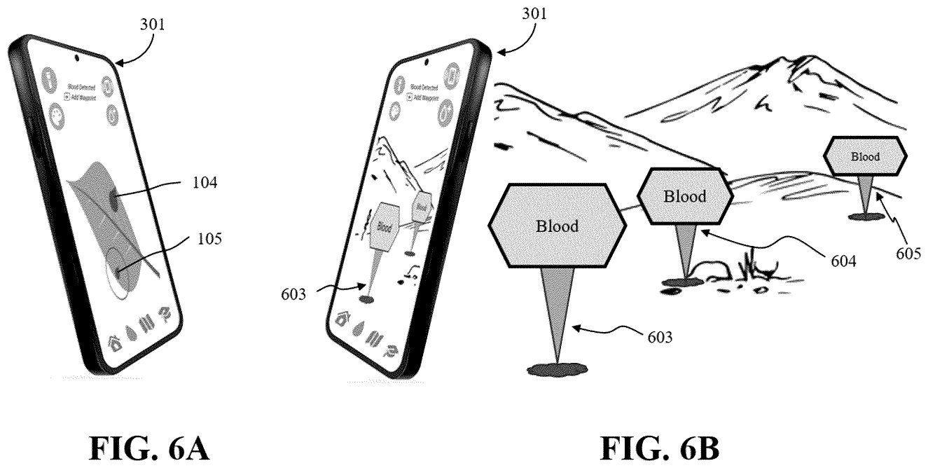

FIG. 6A illustrates an isometric view of the exemplary detection and alerting device 100, which in the embodiment shown is a camera-enabled mobile device (smart phone) 301. The camera-enabled mobile device (smart phone) 301 detects the presence of blood 104 and 105 and generates alerts when blood is detected.

FIG. 6B illustrates an isometric view of the exemplary detection and alerting device 100, which in the embodiment shown is a camera-enabled mobile device (smart phone) 301, where waypoints are selected as described above. In this regard, virtual markers 603, 604, 605 that have been previously created are placed geographically in those locations where blood was detected in the GUI. The mobile device 301 displays the blood detected and simultaneously therewith displays the 3D virtual markers 603-605 in an augmented reality fashion. The processor 200 uses the global positioning system (GPS) 208 (FIG. 2) and inertial measurement sensor(s) to locate the virtual markers 603-605. Cellular phone towers can also be used to support the position of the device 301 via triangulation. As the mobile device 301 is moved the processor 200 may use location and orientation data to superimpose waypoint markers on the image corresponding to the locations of the detected blood.

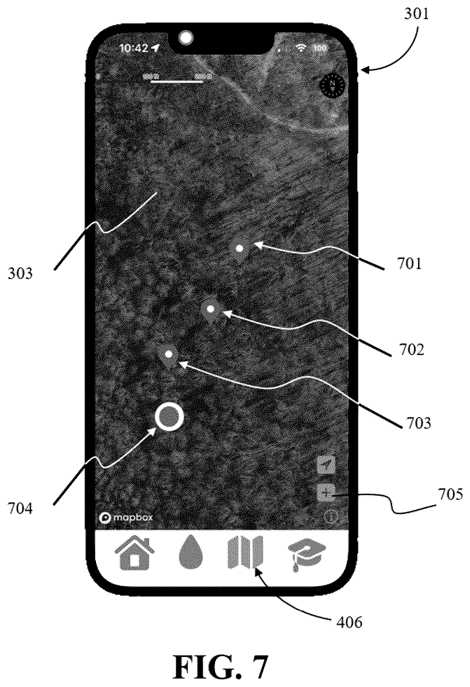

FIG. 7 is the device 301 displaying with a representative GUI 303 containing a map and a plurality of virtual waypoint markers 701, 702, 703 indicating locations of detected blood. The waypoint markers 701-703 indicate locations recorded where blood was detected. The map style can vary (e.g., aerial, contour, etc.) but the waypoint markers 701-703 remains the same. The map presented on the GUI 303 also includes a marker 704 indicating the operator's current location. In one embodiment, the waypoints may be manually added using a control button 705 or removed by pressing and holding the waypoint marker 701-703 located on the map presented to the GUI 303 (FIG. 7).

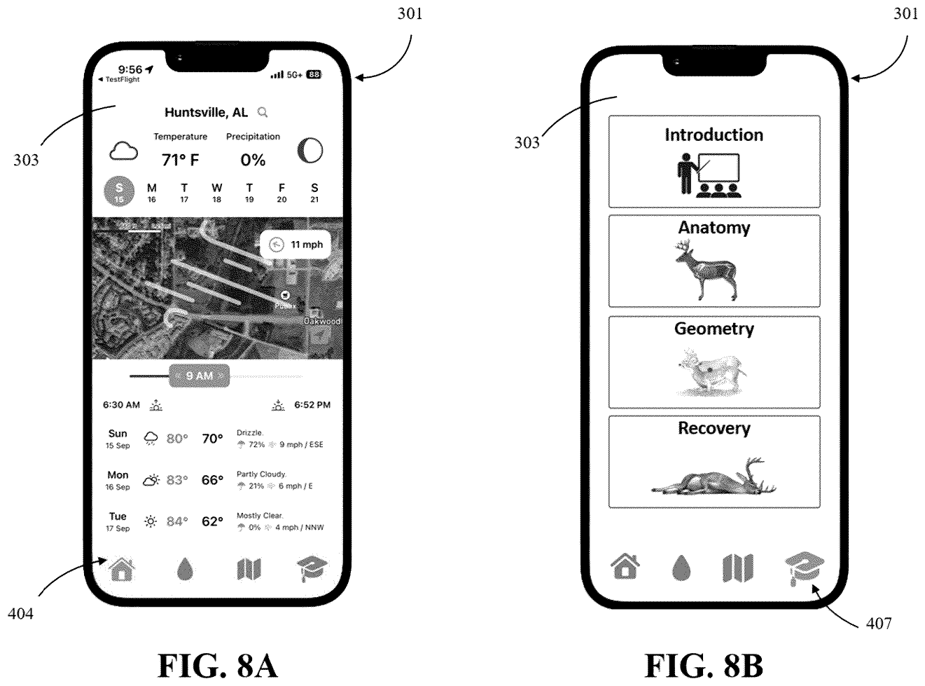

FIG. 8A and FIG. 8B are exemplary GUIs that show two additional exemplary modules of the software (App) that can enhance the game recovery. These two modules are the dashboard module (effectuated by touching the dashboard module icon 404) with exemplary GUI 303 screen content shown in FIG. 8A, and the training module (effectuated by touching the training module icon 407) with exemplary GUI 303 content shown in FIG. 8B. The tracking module is effectuated by touching the tracking module icon 405 (FIG. 4) (shown as a blood drop shaped icon) and is used to detect the presence of blood and to generate alerts as described in detail in this specification. The tracking module (effectuated by touching the tracking module icon 405) provides a secondary function that allows waypoints to be stored when blood is detected. These waypoints can be visualized in a three-dimensional augmented reality fashion within the tracking module 405 or otherwise viewed in a two-dimensional fashion in the mapping module 406. The mapping module 406 is effectuated by pressing the mapping module icon 406 (shown as an unfolded map shaped icon) and can present maps in variety of map styles (satellite, contour, etc.) with waypoint markers presented on these maps at the geographic locations where the blood was detected. The mapping module 406 also displays the location of the operator 704 (FIG. 7) of the device 100 on the maps. A dashboard module 404 presents past, present, and future weather data to include wind speed, wind direction, temperature, and precipitation. The dashboard module 404 is effectuated by pressing the dashboard module icon 404 (shown as a house shaped icon), and also presents moon phase, sunrise, and sunset. All this data is reported for a user specified location (usually at the game recovery location). This data can help indicate the potential onset of inclement weather, which could necessitate an expedient or accelerated recovery. A training module 407 is effectuated by pressing the training module icon 407 (shown as a graduation cap shaped icon) provides relevant information to the user to help increase the likelihood of a successful game recovery. In at least one embodiment the training module 407 contains a general introduction that provides a high-level description of the training material and introduces three basic training sections: anatomy, geometry, and recovery. The anatomy content presents details about the anatomy of the game animals and includes illustrations of the locations of vital organs. The geometry content presents details about the geometry of the shot for both bowhunters and gun hunters. This content illustrates where the vital organs are located for various orientations of the game animal (broadside, quartering towards, quartering away, front, rear), and includes details related to proper shot placement. The recovery content presents a summary of tools and techniques related to successful game recovery. All training material can be presented in video or interactive slide show fashion. Other options could include image recording functions.

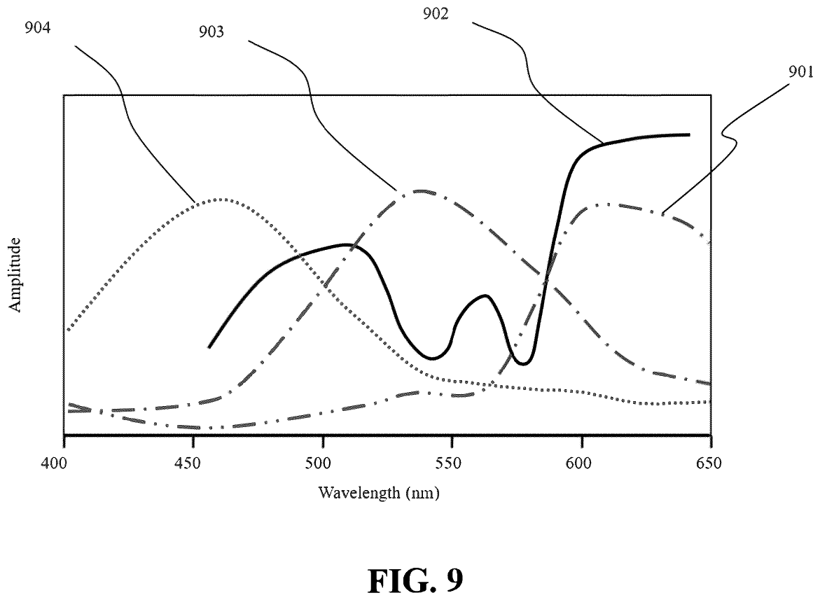

FIG. 9 is a graph 900 overlaying the transmittance spectrum 902 of blood and the spectral responses of the camera 203 (FIG. 2B) RGB pixels, red 901, green 903, and blue 904. The RGB response curves are a result of using Bayer pattern filters, which are typically applied to camera sensors (CMOS, CCD, etc.) to allow them to see color. The Bayer pattern is a technique whereby alternating red, green, and blue filters are applied to the individual pixels of a camera array to produce R, G, B samples. Half of these colored filters are green, and the remainder are split between blue and red. This mimics the human photopic vision where M (medium) and L (long) cones combine to produce a bias in the green region. Blood is imaged by camera 204 (FIG. 2) and converted to color using Bayer or equivalent filters. The spectral distribution of the blood combines with the spectral filtration of the camera filters, and the resultant is processed to detect if blood is present. The transmittance spectrum of blood 902 shows the higher transmittance values are in the red region of the visible light spectrum (e.g., above 620 nm). The transmittance spectrum 902 also shows appreciable transmittance in blue and green regions with relative amplitudes of approximately 50% of blue with respect to red, and approximately 25% of green with respect to red. Daylight testing yields RGB colors like (201,0,15) and (229, 37, 49) for observed blood. Nighttime testing with artificial light (LED flashlight) yields RGB colors like (223, 48, 64) and (209, 13, 42) for observed blood. For camera RGB pixels resulting from blood, the red component is typically larger than the blue component and the blue component is typically larger than the green component. The control logic 202 (FIG. 2) detects blood by examining the intensities of the red, green, and blue components of each pixel. The control logic 202 uses both theoretical data (e.g., data derived from the optical transmittance spectrum of blood) and from field data (e.g. taken from actual images of blood). In a red, green, blue color-space these detected blood pixels would be distributed and would include distinct concentrations (e.g., bright highly-oxygenated blood concentrated in an area versus darker less-oxygenated veinous blood concentrated in another area). A detection volume could be considered to encapsulate all those pixels detected to be blood; and this volume could be represented as singular geometric shape or as a combination of shapes, or as a combination of and deletion of multiple shapes. The control logic 202 exhaustively considers all combinations of red, green, and blue intensities to produce a table that is computed periodically when a user control is changed (e.g., blood detection sensitivity setting), and used to convert and display the imagery. The control logic 202 may perform computations in real-time (without lookup tables) based on the user controls. However, while the lookup table (LUT) would provide definitive determination of each and all combinations of red, green, blue, a detection volume may include some combinations of RGB within the volume that are not actually detected as blood.

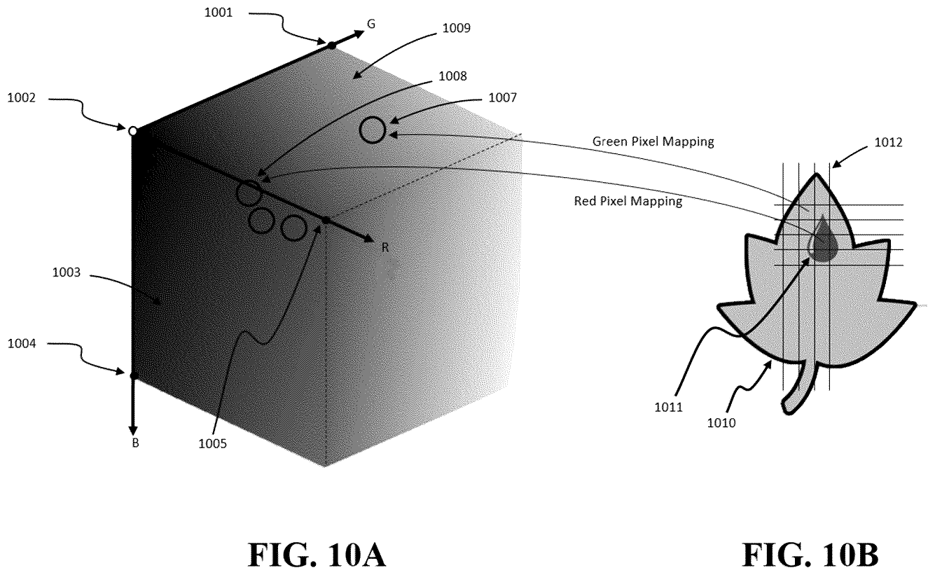

FIG. 10A is an RGB color-space cube 1000. The camera 204 (FIG. 2) and processor 200 (FIG. 2B) map real world colors into the color-space represented by the RGB color-space cube 1000. In this regard, with each pixel having red (R), green (G), and blue (B) pixel, intensity values ranging from 0 to 255. Abstractly, RGB color-space cube 1000 is a three-dimensional cube representation of the R, G, B axes. The RGB color-space cube 1000 comprises a vertex 1002 located at RGB (0,0,0) and a G-axis extending out to a location 1001 with RGB coordinates (0, 255, 0). The RGB color-space cube 1000 comprises a B-axis that extends out to a location 1004 with RGB coordinates (0, 0, 255) and an R-axis that extends out to a location 1005 with RGB coordinates (255, 0, 0). The RG plane 1007 is a location where B equals to 0. The RB plane 1003 is a location where G equals 0.

FIG. 10B shows a leaf 1010 with a single blood drop 1011 and illustrates how the camera 204 (FIG. 2B) divides the images into pixels shown here as a grid 1012 of horizontal and vertical lines. The RGB values of the center pixel within the blood drop 1011 maps into the RGB color-space cube to the specific RGB coordinate 1008. In similar fashion the RGB values of a pixel on a green leaf surface might map into the RGB color-space to a specific RGB coordinate 1007. Blood is observed in a variety of color variations, as the color of blood is affected by several factors such as levels of oxygenation, time outside the host's body, and environmental conditions. Therefore, the RGB coordinates for variations of blood will be distributed throughout the RGB color-space with observable concentrations generally along the red axis 1005. A detection volume could be devised such as to encapsulate these various RGB coordinates that pertain to blood. Then any combination or R, G, and B would be evaluated to see if it is inside (therefore detected as blood) or outside (therefore detected to not be blood) of the detection volume. In one embodiment, the control logic 202 approximates a geometric shape such as a pyramid or an elliptical paraboloid, or approximated as combinations of shapes, and perhaps include combinations and subtractions of geometric shapes. While the control logic 202 use all combinations of RGB that pertain to variations of blood, it may however include combinations of RGB coordinates for colors that do not actually pertain to blood.

The control logic 202 (FIG. 2) used to detect the presence of blood can be executed in real-time or can leverage pre-computed lookup tables (LUTs). Real-time algorithms are computationally intensive as they involve the examination of the individual pixels of the camera 204 (FIG. 2) images 107 (FIG. 1) at very high rates (e.g., 30 images per second with as many as 3,013,524 pixels per image). Processor 200 today are available with multiple processor cores, embedded graphical processing units, and capable of billions of instructions per second. However, there are times when pre-computed lookup tables can be used to reduce computational complexity. RGB lookup tables can be built to contain the results of the required computations of the blood detection control logic 202 for all combinations of red (R), green (G), and blue (B). Regardless of implementation (real-time, lookup table, etc.), the blood detection control logic 202 is applied to the RGB pixel values of the camera imagery, and may involve ratios of these components, multi-band ratios of these components (described later), and even include approximations by way of detection volumes.

The control logic 202 examines the R (red), G (green), and B (blue) components of the image pixels, and considers the relative amplitudes among other things, and further involves evaluations of ratios of the R, G, and B components (e.g., R/B, B/G, R/G), and it is the linearity of these ratios that can produce a detection volume that appears as a pyramid shape.

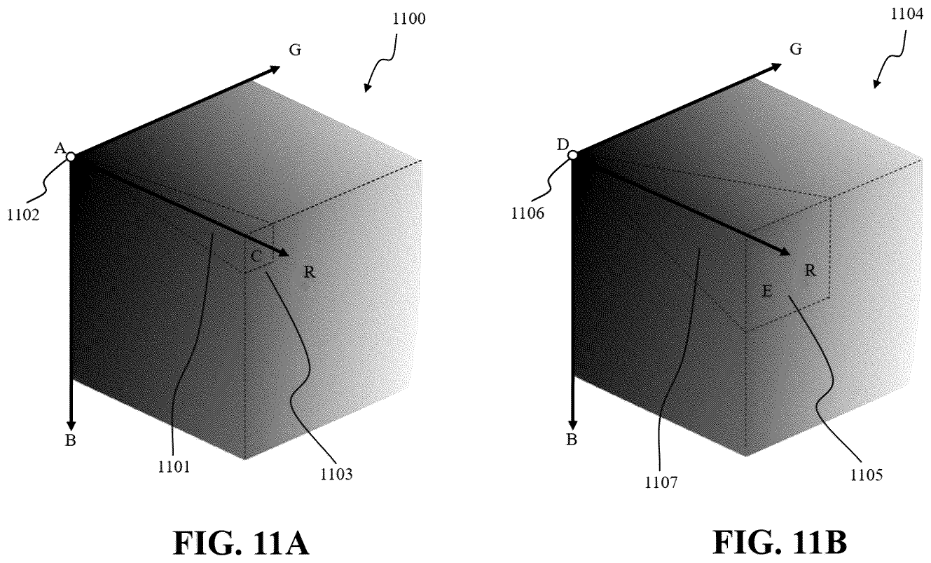

FIG. 11A is an RGB color-space cube 1100 with a pyramid shaped volume 1101 defined by the vertex (point A) 1102 and the surface C 1103 shown. RGB pixels falling within this pyramid shaped volume are detected as blood. The size of surface B 1103 and the resulting pyramid shaped volume 1101 are detected by the blood detection sensitivity control setting.

FIG. 11B shows the RGB color-space cube 1104 with a pyramid-shaped representation 1107 defined by a vertex (point D) 1106 and a surface E 1105. This volume 1107 is larger than the volume 1101; and as such the larger 1107 volume allows a larger number of colors to be considered as blood detected; while a smaller volume of the pyramid-shaped representation 1101 allows a smaller number of colors to be considered as blood detected colors. Again, the size of the pyramid-shaped representation 1107 abstractly shows the way processor 200 reacts to manipulation of the blood detection sensitivity control setting 409 (FIGS. 4A and 4B).

Reaction to the manipulation of the blood detection sensitivity setting 409 (FIG. 4) can be based on multi-band ratio calculations that are applied to each RGB (red, green, blue) pixel (not shown) from the device 301 (FIGS. 3A and 3B), and the processor 200 (FIG. 2) applies the selected blood detection sensitivity to these calculated values to detect if a pixel is blood detected. Processor 200 performs calculations mathematically in real-time or prepares them a priori into lookup tables (LUTs) to reduce the computational load on the processor 200. If a calculated value is above the blood detection sensitivity threshold, then it is considered blood detected. If the calculated value is equal to or below blood detection sensitivity threshold it is considered not to be blood detected and subsequently the processor 200 will convert the calculated value per the background style control setting 503 (FIG. 5). The processor 200 computes multi-band calculations as follows:

$$RatioRG = ( R - G ) / ( R + G )$$

$$RatioRB = ( R - B ) / ( R + B )$$

Where R represents the red component of the RGB color pixel, G represents the green component of the RGB color pixel, and B represents the blue component of the RGB color pixel. R, G, and B are integers that range between 0 and 255. The processor 200 applies a divide by zero condition check to handles divisions where both R and G exhibit 0 values, and where R and B exhibit 0 values. The processor 200 builds a RatioRG lookup table (not shown) for all combinations of R and G, with the LUT entry set to one (indicating blood detected) when the ratio is above the “blood detection sensitivity threshold” control setting (e.g., a value of 0.6) or is otherwise set to zero to indicate the color is not blood detected. The processor 200 builds a RatioRB lookup table for all combinations of R and B with the LUT entry set to one (indicating blood detected) when the ratio is above the “blood detection sensitivity threshold” control setting (e.g., 0.6) or is otherwise set to zero to indicate the color is not blood detected. After the RatioRG and RatioRB lookup tables are built, the processor 200 inputs one or more pixels of the camera 204 into the LUTs, and the processor 200 logically ands the RatioRG LUT and RatioRB LUT values together to detect if a blood detected pixel has been detected. Both LUTs may contain a value of one to indicate a blood detected. Field testing has shown that when the blood detection sensitivity threshold computed multi-band values are above 0.6, the processor 200 typically classifies blood correctly. The LUTs are recomputed by processor 200 (FIG. 2) each time the blood detection sensitivity threshold setting is changed by the user. The blood detected pixels represent the presence of blood and trigger alerts to an operator (not shown) of device 301 (FIGS. 3A and 3B). The processor 200 may alert the operator through visual methods, like simply rendering the blood detected pixels on the display 302 (FIGS. 3A and 3B), or by blinking the blood detected pixels on the display 302 or displaying a separate visible alert (e.g., like the “Blood Detected” message above the dynamic waypoint control 403 (FIG. 4)) on the display 302. In one embodiment, the alerts can include audible alerts such as beeps, tones, or any desired sounds. The alerts can also include vibration where the intensity of the vibration can be fixed or even vary proportionally to the amount of blood present in the image. It should be mentioned that the RatioRG LUT and RatioRB LUT can be combined into a single RGB LUT, or perhaps a single RatioRG LUT can in some cases suffice. It should also be mentioned that the processing can be performed without the use of LUTs, in which case the computations are performed in real-time.

In one embodiment, processor 200 monitors a camera f-stop and exposure time. There are extreme cases that affect the quality of the resultant RGB values (e.g., very fast exposure times above approximately 1/1800 sec, and very slow exposure times below approximately 1/20 sec). The processor 200 may monitor the exposure time and apply it as a confidence measure used by the device 100 or simply presented to the operator. If the exposure time is considered too short or too long, then the device 100 could notify the operator. These notifications could instruct the operator to introduce additional lighting in cases where the exposure time is very long; and reduce the lighting (e.g., via neutral density filter) in cases where the exposure time is very short.

In one embodiment, artificial intelligence (AI) may be used by processor 200 to optimize the implementation. In this regard, the processor 200 may automatically select the control settings of a control panel based on a myriad of data scenarios (e.g., time of day, time of year, geographic location, weather conditions, atmospheric conditions, camera exposure time, etc.). Perhaps even control the light intensity.

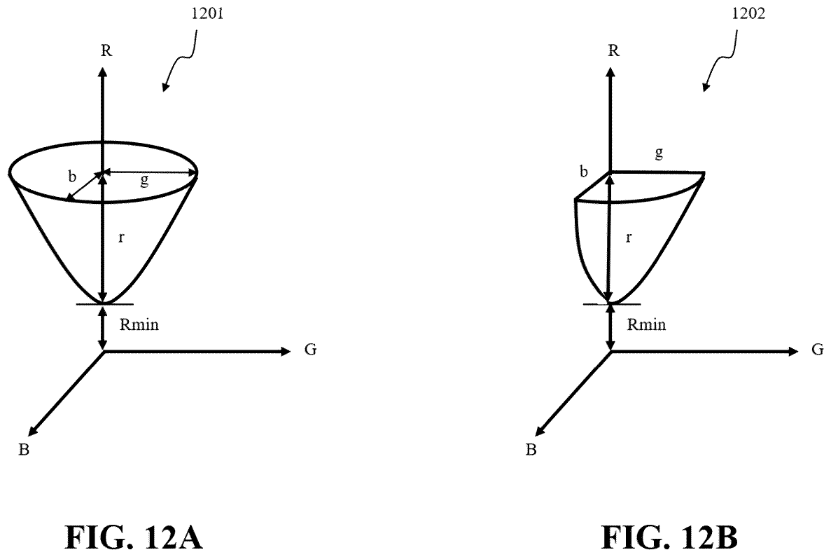

FIG. 12A shows how the detection volume 1201 (previously modeled as a pyramid shaped volume) can be modeled as an elliptical paraboloid with the R, G, and B radii specified by values r, g, and b. An additional offset value “Rmin” is used to further constrain the shape of the volume.

FIG. 12B shows the portion of an elliptical paraboloid 1202 that resides inside of the RGB color-space cube. The blood detection sensitivity control setting adjusts the r, g, b radii and the Rmin value, which detect the size of the volume. A single blood detection sensitivity control can be used to vary the r, g, b, and Rmin parameters, or multiple blood detection sensitivity controls can be used to vary the r, g, b, and Rmin parameters.

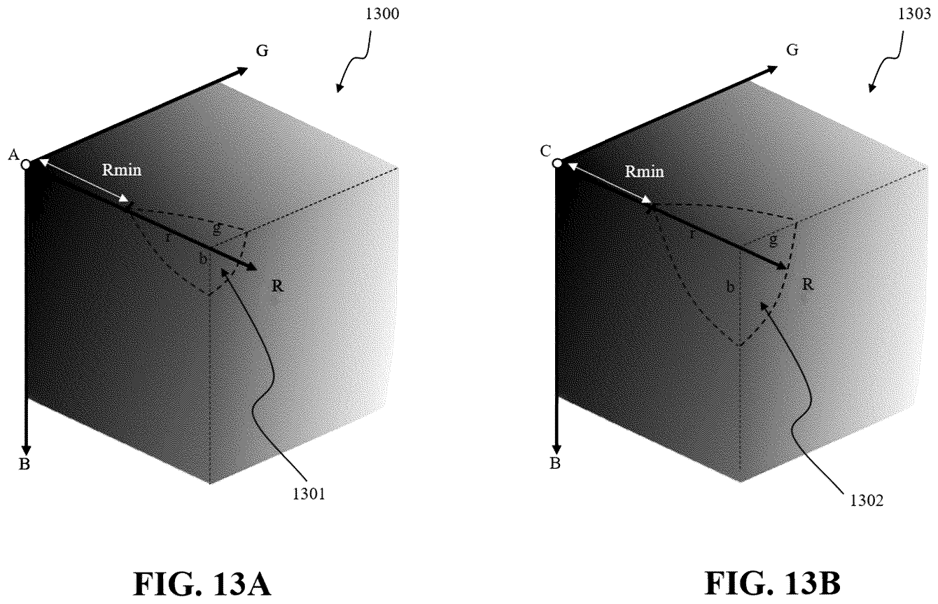

FIG. 13A shows the RGB color-space cube 1300 with an elliptical paraboloid shaped detection volume 1301 superimposed with an offset on the R axis specified by Rmin, and the R, G, and B radii defined by values of r, g, and b.

FIG. 13B shows the RGB color-space cube 1303 with a larger elliptical paraboloid shaped detection volume 1302 superimposed with an offset on the R axis specified by Rmin, and the R, G, and B radii defined by values of r, g, and b. Again, the blood detection sensitivity control setting, when selected, control the size of the detection.

The detection volume is intended to contain all colors considered to be blood detected colors; and as such the detection volume can be defined as pyramid, elliptical paraboloid, or combinations of these and other geometric shapes. Portions of the volume can be eliminated; and additional points and volumes can be added to expand the definition of the detection volume.

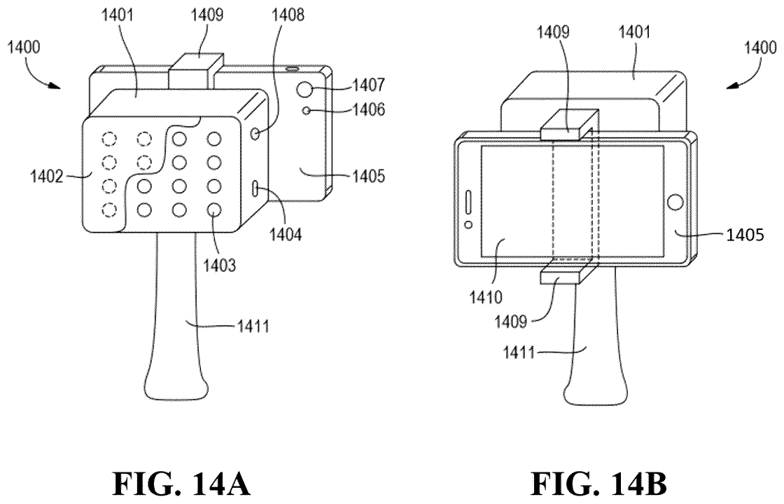

FIG. 14A is a front view of a handheld device 1400 according to one embodiment of the present disclosure. In such an embodiment, the handheld device 1400 delivers alerts to the operator when it detects the presence of blood. A light module 1401 hosts a set of sixteen LEDs 1403 (light emitting diodes) with these LEDs 1403 behind a light diffuser 1402. The light diffuser 1402 is a translucent or semi-transparent cover that spreads out or scatters the light from light module 1401. Using the light diffuser controls brightness and gives off a soft light relative to light 1401. The light 1401 has an On/Off switch 1408 and a charging port 1404 in the case where rechargeable batteries are employed. The light 1401 supplements a smart phone light with a bright diffused light source. A mobile smart phone device 1405 (with camera 1407 and integral light 1406) is held in place by an adjustable clamp 1409 that is designed to accommodate all or at least a wide range of commercially available mobile smart phone devices. A handle 1411 is included and its length can be short and compact; or long like a selfie-stick. The construction allows the vibratory alerts to be felt through the handle.

FIG. 14B is a rear view of device 1400 according to an embodiment of the present disclosure. In such an embodiment, the handheld device 1400 delivers alerts to the operator when it detects the presence of blood. The light module 1401 faces away from the operator. The mobile smart phone device 1405 is held in place with the adjustable clamp 1409 so that a display device 1410 is visible to the operator while holding the device 1400. Again, the construction allows the vibratory alerts to be felt through handle 1411.

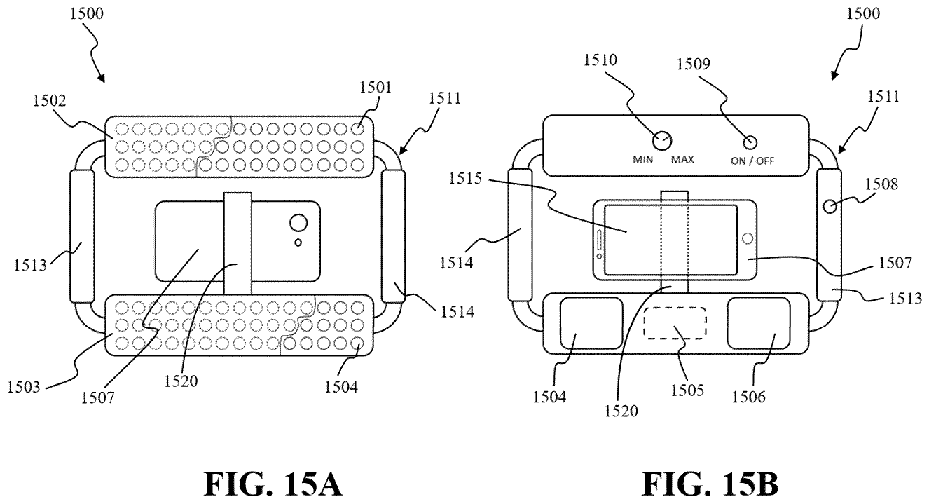

FIG. 15A is a front view of a device 1500 according to an embodiment of the present disclosure. The device 1500 comprises a frame 1511 and a mobile smartphone device 1507. In use, the operator grasps handles 1513 and 1514. device 1500 delivers alerts to an operator when it detects the presence of blood. The mobile smart phone device 1507 is held in place with an adjustable clamp 1520. A pair of diffused light modules 1502 and 1503 provide a total of 90 LEDs (1501 and 1504). The frame 1511 with side handles 1513 and 1514 hosts the components and forms the device 1500.

FIG. 15b is a rear view of device 1500 according to an embodiment of the present disclosure. device 1500 delivers alerts to an operator when it detects the presence of blood. The mobile smart phone device 1507 is held in place with an adjustable clamp 1520. A pair of removeable and rechargeable batteries 1504 and 1506 provide power to the diffused light modules and Bluetooth electronics module 1505. A display screen 1515 is visible to the operator as the mobile smart phone device 1507 is held in place by an adjustable clamp 1520. Light intensity is controlled by an On/Off button 1509 and a dimmer dial 1510. A Bluetooth button 1508 is included to provide an alternate means to initiate features such as mapping functions. The frame 1511 with side handles 1513 and 1514 integrates the components to form a complete device.

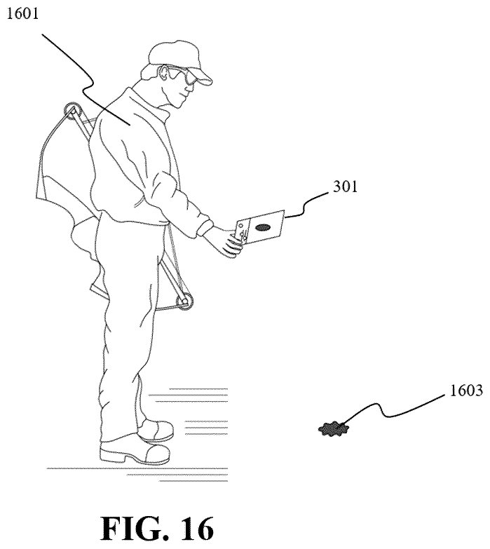

FIG. 16 shows an operator (e.g., a hunter) 1601 operating detection and alerting device 100 in a hand-held capacity. The operator 1601 looks at the display 302 of device 100 while moving it over the ground searching for blood 1603. The visual, audible, and vibratory alerts notify the operator when blood has been detected.

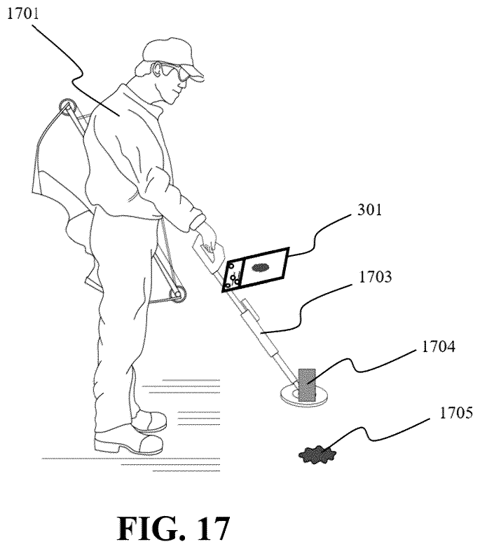

FIG. 17 shows an operator (e.g., a hunter) 1701 using a smart phone device 301 (FIGS. 3A and 3B) with an extension-pole 1703 fashioned after a metal detector frame. The operator moves the device, which is comprised of a metal detector frame 1703, a smart phone device 301, and a Wi-Fi camera module 1704 mounted at the end of the frame 1703. The Wi-Fi camera module 1704 transmits imagery to smart phone device 301. Smart phone device 301 performs the processing based on the control settings. The operator 1701 moves the camera module 1704 over the ground looking for blood 1705. The visual, audible, and vibration alerts notify the operator when blood has been detected. The audio could mimic the sounds of a traditional metal detector (crackling squelch with tones) in this (or any) configuration.

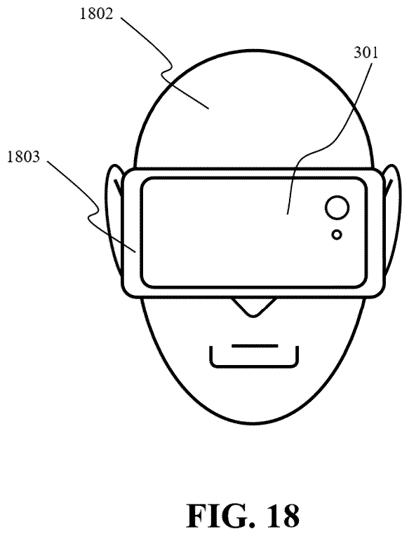

FIG. 18 is an operator 1802 wearing the smart phone device 301 in an extended reality headset (XR headset) capacity, that physically hosts the smart phone device 301 (FIGS. 3A and 3B). Smart phone device 301 is mounted in a headset carrier 1803 with the display facing the operator's eyes. The operator moves the smart phone device 301 around by moving his/her head looking for blood. The visual, audible, and vibratory alerts notify the operator when blood has been detected.

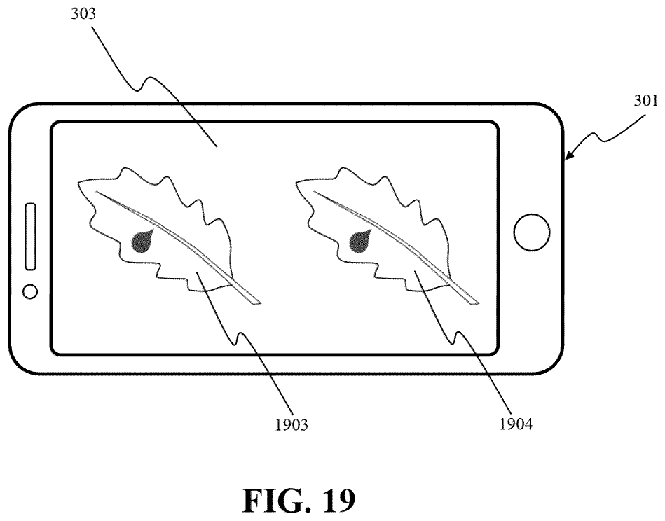

FIG. 19 is a display GUI 303 in accordance with an embodiment of the present disclosure and which supports the smart phone device 301 (FIGS. 3A and 3B) mounted as a headset. In such an embodiment, the processor 200 (FIG. 2) displays imagery on the GUI 303 duplicated in two places on the screen (1903, 1904) where the operator's left eye (not shown) is presented the left image 1903 and the operator's right eye (not shown) is presented the right image 1904. The graphics for the controls are hidden during operation. This can also be achieved by using commercial XR headset devices like the Apple Vision Pro and the Meta Quest.

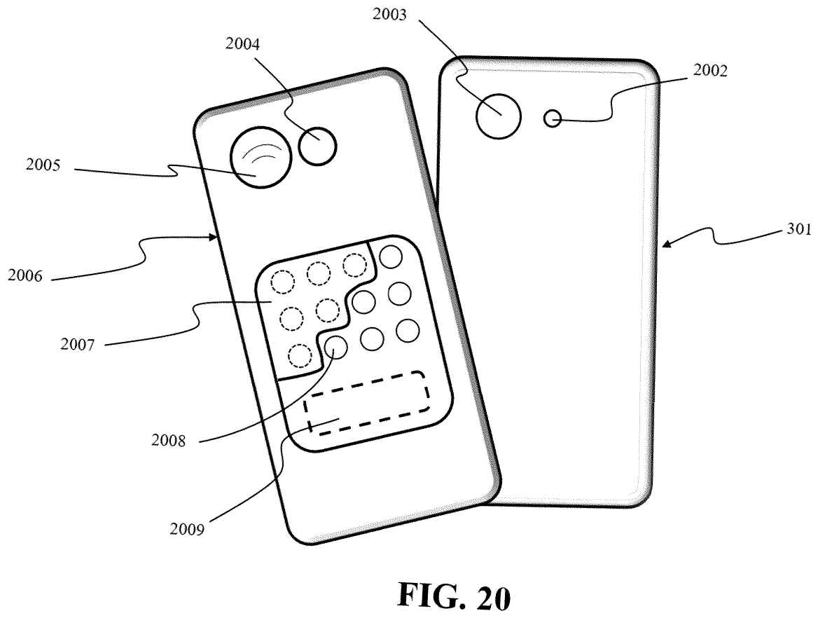

FIG. 20 is the smart phone device 301 combined with a device caddy 2006. The caddy 2006 comprises additional lighting via a diffused light 2007 comprising a plurality of LEDs 108. Further, the caddy comprises optical magnification and/or filtration to a camera 2003 via a lens 2005. The light 2007 is powered by a battery 2009. A cut-out 2004 allows the existing light 2002 on the smart phone device 301 to shine through.

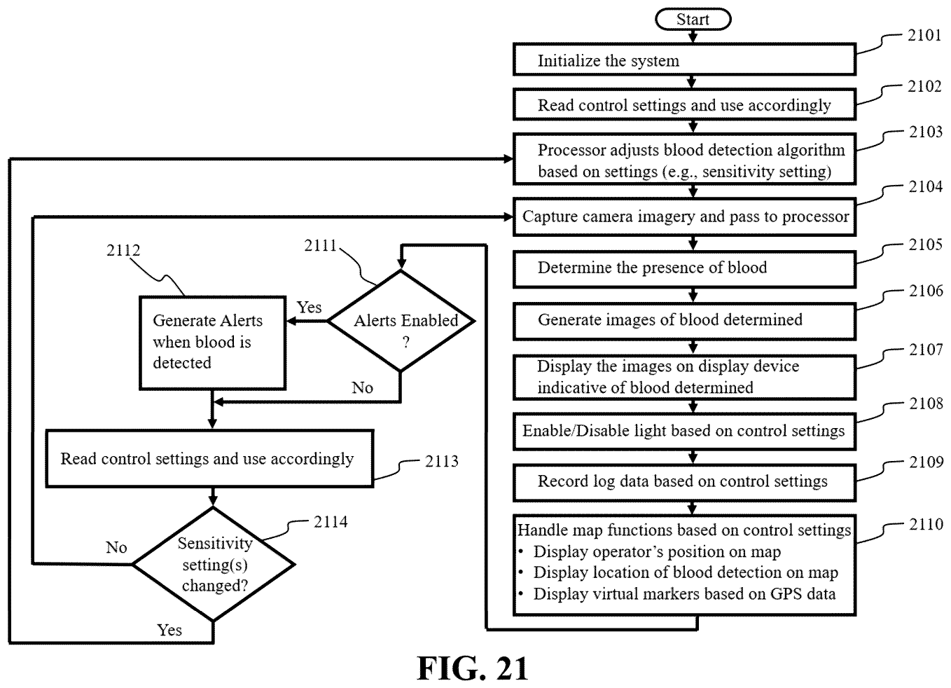

FIG. 21 is a flowchart of exemplary architecture and functionality of the device 100 (FIG. 1). In step 2101, the processor 200 (FIG. 2) initializes the device. Initialization consists of powering up the device 100 and launching control logic 202 (FIG. 2). In step 2102, the processor 200 reads the control settings and the control settings are retained for use until otherwise changed. The processor 200 uses customary interrupt and polling methods to retrieve changes in the control settings. In step 2103, the processor 200 adjusts the blood detection algorithms based on control settings (e.g., sensitivity setting 409 FIG. 4). If the processor 200 executes the control logic 202 in real-time computations, the control logic 202 applies the settings to the computations performed by the control logic 202. If the processor 200 executes the control logic 202 using lookup tables, the control logic 202 applies settings to the recomputing of the lookup tables. In step 2104, the processor 200 captures camera imagery. In step 2105, the processor 200 detects if there is blood present in the camera imagery. In step 2106, the processor 200 generates resultant images based on the control settings. The processor 200 converts pixels that it detects to be blood using the user specified blood presentation color (specified by the blood presentation control 502 (FIG. 5)). The pixels that the processor 200 detects to not be blood are converted per the user specified control 503 (FIG. 5). A flag is set when one or more pixels in the image 107 (FIG. 1) are detected as blood. This flag is used to trigger alerts. In step 2107, the resultant images are displayed to the user. In step 2108, the processor 200 optionally uses a light function (e.g., LEDs) to increase the available light. The processor 200 uses a light control setting 401 (FIG. 4) to enable and disable this function. In step 2109, the processor 200 uses a log function to record specific data to include geographical waypoint locations and device orientation data. In step 2110, the processor 200 supports a series of map functions and displays waypoint markers on the maps and displays virtual markers in an augmented reality fashion based on GPS and inertial sensor readings. The map functions include a feature to display maps on a portion (or over the entirety) of the display, and to overlay waypoints onto the map that relate to geographic locations of the blood and/or the operator. In step 2111, the processor 200 evaluates the control setting that enables and disables the alerts accordingly. In step 2112, the processor 200 enables alerts and evokes alerts when blood is detected, and the alerts are presented to the operator in a variety of forms to include visual, audible, and vibratory. If alerts are disabled, then the processor 200 disables the presentation of the alerts. In step 2013, the processor 200 evaluate control settings to see if there have been any changes. The changes are detected via standard software interrupts and polling. In step 2114, the processor 200 evaluates the control setting(s) (e.g., blood detection sensitivity 409) to detect if there has been a change in the setting. In one embodiment, each time a blood detection sensitivity setting changes, the processor 200 recomputes the LUTs. If the blood detection sensitivity settings have not changed, then the processor 200 does not recompute the LUT. It should be mentioned that LUTs are included for the purpose of reducing computational load on the processor; however, these computations could otherwise be performed in real-time without the use of LUTs.

What I claim is:

1. A device, comprising:
a camera;
a display;
a processor configured for determining the presence of blood based on images captured by the camera and generating images on the display indicative of the blood detected.

2. The device of claim 1, wherein the processor is further configured for generating alerts when the blood is detected.

3. The device of claim 2, wherein the device further comprises a speaker and the alert is an audible alert.

4. The device of claim 2, wherein the device further comprises a vibrator and the alert is a vibratory alert.

5. The device of claim 2, wherein the alert is a visual alert on the display.

6. The device of claim 1, further comprising a control setting, the processor further configured to perform color conversion to a plurality of pixels of the images that are detected as blood.

7. The device of claim 6, wherein the processor is configured to perform null conversion on pixels determined to be blood and display data indicative of the color of the blood detected.

8. The device of claim 6, wherein the processor is configured to convert pixels determined to be blood to red and display data indicative of the converted pixels.

9. The device of claim 6, wherein the processor is configured to convert pixels determined to be blood to green and display data indicative of the converted pixels.

10. The device of claim 6, wherein the processor is configured to convert pixels determined to be blood to yellow and display data indicative of the converted pixels.

11. The device of claim 1, further comprising a control setting, the processor further configured to perform color conversion to a plurality of pixels of the images that are determined not to be blood.

12. The device of claim 11, wherein the processor is further configured to convert pixels determined not to be blood to shades of gray and display data indicative of the converted pixels.

13. The device of claim 11, wherein the processor is further configured to convert pixels determined not to be blood to shades of blue and display data indicative of the converted pixels.

14. The device of claim 11, wherein the processor is further configured to convert pixels determined not to be blood to a fixed color and displaying data indicative of the converted pixels.

15. The device of claim 1, wherein the processor is further configured to display geometric shapes corresponding to the data indicative of the blood detected.

16. The device of claim 15, wherein the geometric shape is a circle.

17. The device of claim 15, wherein the geometric shape is a rectangle.

18. The device of claim 1, further comprising a sensitivity control with a range spanning a low setting to a high setting.

19. The device of claim 18, wherein the sensitivity control is configured for selection to a low control setting, and the processor is further configured to detect arterial blood.

20. The device of claim 19, wherein the sensitivity control is configured for selection to a high control setting, and the processor is further configured to further detect blood exhibiting color different than arterial blood.

21. The device of claim 1, wherein the processor is further configured for locating a position of the detected blood.

22. The device of claim 1, wherein the processor is further configured to store data indicative of waypoints as selected by an operator.

23. The device of claim 22, wherein the processor is further configured to display data indicative of the waypoints selected by the operator as requested by the operator.

24. The device of claim 1, wherein the processor is further configured for locating position and orientation of the device.

25. The device of claim 24, wherein the processor is further configured to store data indicative of three-dimensional virtual waypoints as selected by an operator.

26. The device of claim 25, wherein the processor is further configured to display data indicative of the three-dimensional virtual waypoints in an augmented reality fashion as requested by the operator.

27. The device of claim 1, further comprising a handle.

28. The device of claim 27, wherein a light diffuser is configured to spread or scatter light delivered to the display.

29. The device of claim 1, further comprising a frame.

30. The device of claim 29, wherein the frame further comprises one or more handles.

31. The device of claim 1, further comprising an extension-pole and the camera is positioned at an end of the extension pole at or near the ground.

32. The device of claim 1, further comprising an extended reality headset.

33. The device of claim 32, wherein the processor is further configured to display the image and a second image identical to the image to the display.

34. The device of claim 1, further comprising a device and a diffused light.

35. The device of claim 1, further comprising a caddy, wherein the caddy comprises an optical magnification and/or filtration device to the camera via a lens.

36. A method, comprising:
determining, by a processor, the presence of blood based on images captured by a camera; and
generating, by the processor, images on a display data indicative of the blood detected.

37. The method of claim 36, further comprising generating, by the processor, alerts when the blood is detected.

38. The method of claim 37, further comprising generating, by the processor, alerts on a speaker and the alert is an audible alert.

39. The method of claim 37, further comprising generating, by the processor, alerts on a vibrator and the alert is a vibratory alert.

40. The method of claim 37, further comprising generating, by the processor, a visual alert on the display.

41. The method of claim 36, further comprising performing, by the processor, color conversion to a plurality of pixels of the images that are detected as blood.

42. The method of claim 41, further comprising:
performing, by the processor, a null conversion on pixels determined, by the processor, to be blood; and
displaying, by the processor, data indicative of the color of the blood detected to the display.

43. The method of claim 41, further comprising:
converting, by the processor, pixels determined to be blood to red; and
displaying, by the processor, data indicative of the converted pixels to the display.

44. The method of claim 41, further comprising:
converting, by the processor, pixels determined to be blood to green; and
displaying, by the processor, data indicative of the converted pixels to the display.

45. The method of claim 41, further comprising:
converting, by the processor, pixels determined to be blood to yellow; and
display, by the processor, data indicative of the converted pixels.

46. The method of claim 36, further comprising performing color conversion to a plurality of pixels of the images that are determined not to be blood based upon a control setting.

47. The device of claim 46, further comprising:
converting pixels, by the processor, determined not to be blood to shades of gray; and
displaying, by the processor, data indicative of the converted pixels to the display.

48. The method of claim 46, further comprising:
converting, by the processor, pixels determined not to be blood to shades of blue;
displaying, by the processor, data indicative of the converted pixels.

49. The method of claim 46, further comprising:
converting, by the processor, pixels determined not to be blood to a fixed color; and
displaying, by the processor, data indicative of the converted pixels.

50. The method of claim 36, further comprising displaying, by the processor, geometric shapes corresponding to the data indicative of the blood determined.

51. The method of claim 50, further comprising displaying, by the processor, the geometric shape of a circle corresponding to the data indicative of the blood determined.

52. The method of claim 50, further comprising displaying, by the processor, the geometric shape of a rectangle corresponding to the data indicative of the blood determined.

53. The method of claim 52, detecting, by the processor, arterial blood when a low control setting is selected by an operator.

54. The method of claim 53, further comprising further detecting, by the processor, blood exhibiting a color different than arterial blood.

55. The method of claim 36, locating, by the processor, a position of the detected blood.

56. The method of claim 36, further comprising storing, by the processor, data indicative of waypoints as selected by an operator.

57. The method of claim 56, further comprising detecting, by the processor, data indicative of the waypoints selected by the operator as requested by the operator.

58. The method of claim 36, further comprising locating, by the processor, a position and an orientation of the device.

59. The method of claim 36, further comprising storing, by the processor, data indicative of three-dimensional virtual waypoints as selected by an operator.

60. The method of claim 60, further comprising displaying, by the processor, data indicative of the three-dimensional virtual waypoints in an augmented reality fashion as requested by the operator.
